(19) United States
(12) Patent Application Publication
(10) Pub. No.: US 2009/0098503 A1
(43) Pub. Date: Apr. 16, 2009

(54) Foam-generating, hardening compositions for forming impressions of surfaces and impression trays for use therewith

(75) Inventors: GOTTFRIED KNISPEL, Leverkusen (DE); Martin Grunwald, Pulheim (DE); Andreas Grundler, Dormagen (DE)

Correspondence Address: NORRIS, MCLAUGHLIN & MARCUS, P.A., 875 THIRD AVE, 18TH FLOOR, NEW YORK, NY, 10022, US

(73) Assignee: Heraeus Kulzer GmbH, Hanau (DE)

(21) Appl. No.: 12/062,065

(22) Filed: Apr. 3, 2008

(30) Foreign Application Priority Data
Apr. 5, 2007 (DE) 10 2007 016 791.3

(51) Int. Cl. A61C 9/00; C08J 9/35

(52) U.S. Cl. 433/37; 521/86

(57) ABSTRACT

Foam-generating, hardening composition for making impressions of biological surfaces include A at least one impression material based on
i isocyanates, which react with mono- and multi-functional amines and/or compounds having hydroxyl groups, to form urethane or urea, or
ii A-silicones, or
iii C-silicones, or
iv Polyethers, or
v alpha-silanes, or
vi mixtures of two or more materials i to v, and
   optionally B
   at least one foaming agent. Impressions of biological surfaces made from this compound have a foam with closed pores.

The invention relates to foam-generating, hardening compositions for forming impressions of surfaces, as well as impression trays for use therewith.

Irreversible plastic impression materials, such as alginates, polysulfides, C- or A-silicones, or polyethers are based on two components which must be homogenized and reacted with one another, before the impression is formed, by a complex process either by hand or by using static or dynamic, hand-operated or electrically driven mixing systems, for example mixing systems presently used in dentistry.

### BACKGROUND

DE 19505896A1 (corresponding to U.S. Pat. No. 6,040,354) discloses a readily mixable impression material with high texture definition. Desirable is the consistency of whipping cream, i.e., the material should be easily deformable, but still firm. DE 19505896A1 proposes formation of a micro-fine crystal mesh in the pastes. These are free of bubbles.

Foamed silicone materials or silicone materials containing foaming agents are known in the art.

DE3210094 is directed to in situ formation of hollow microspheres in silicone impression materials by using foaming agents.

DE4029888A1 (corresponding to U.S. Pat. No. 5,256,726) discloses reactive systems which are potentially useful as impression materials for the preparation of polyurethanes, which may be provided as foams. However, the disclosure does not suggest a connection between forming an impression and foam. It therefore remains an open question if the foamed variant is recommended or suitable as material for a forming impressions.

DE10100736C2 is directed to a release agent based on organosilicone, wherein bubbles are formed by using a propellant. However, this material is not employed for forming impressions.

U.S. Pat. No. 4,677,139 is directed to a foam composition for use in dentistry, for example as wound dressing or compression dressing, or more particularly for temporarily separating the gum from the tooth, for example to facilitate obtaining impressions or in gum surgery.

Another material is the product Magic Foamcord, distributed by the company Coltène/Whaledent Inc. The material is used for sulcus expansion, but not for impressions, and also does not contain a foaming agent (EP1603480A1).

With this product, the surface making contact (the sulcus) is expanded by the expanding material. This characteristic distinguishes over a foam for making impressions of surfaces, because the foam must not alter the surface structure; otherwise, the accuracy of the impression would be adversely affected. Moreover, unlike the present invention, the product Magic Foamcord expands only through reaction with water, or humidity in the air, which expands its lumen through the foaming action.

DE10108038C1 (corresponding to U.S. 2004/007291) and -9C1 describe isocyanate-free, foamable mixtures with foaming agents. The application is limited to the production of industrial spray foams for construction projects and for device insulation. The non-toxic material is particularly recommended for minimizing the risk to non-commercial users.

### SUMMARY

It is an object of the present invention to provide a composition which obviates the need for using manually operated and/or electrically driven mixing systems and which can in addition also produce a foam structure.

A further object is to provide an impression tray for use with the composition of the invention.

### DETAILED DESCRIPTION OF THE INVENTION

The present invention is directed to a foam-generating, self-supportingly hardening composition for forming impressions of biological surfaces, in particular a dental composition, preferably containing a foaming agent, based on isocyanates, which react, for example, with mono-functional and multi-functional amines and/or with materials containing hydroxyl groups by forming urethane or urea, or A-silicones, or C-silicones or polyethers, or one or more alpha-silanes, or mixtures of thereof.

Advantageous embodiments are:
Compositions comprising the base paste of an A-silicone impression material and the catalyst paste of an A-silicone impression material.
Compositions comprising an impression material based on at least one tri-, di-, or monoalkoxy-alpha-silane.
Compositions comprising as component the base paste of a polyether impression material and the catalyst paste of a polyether impression material.
Compositions comprising as component an impression material based on an alpha-amino-trimethoxy-silane.

The invention also relates to an impression of biological surfaces made from such impression material, in particular a human impression, such as a dental impression, with a foam having closed pores.

Particularly suitable are materials based on a tri-, di- or mono-alkoxy-alpha-silane (e.g., an alpha-amino-trimethoxy-silane).

The preferably employed alpha-silanes are commercially available, for example, from the company Wacker. They are presently used in building foams, for example for attaching door components and for insulation. The foams have significantly lower toxicity than conventional isocyanate-based foams.

The hardening foam according to the invention has the following advantages:
The material has a low density and therefore has a very small insertion resistance when applied with an impression tray.
When using alpha-silanes, the potential toxicity is low (while still exhibiting high reactivity) compared to isocyanates used in conventional foams.
In an embodiment with a high fraction of propellant gas in the foam, the foam pressure generated by the foaming agent, which expands in the impression material during formation of the impression, can result in improved surface conformity—filling cavities and lumens automatically, thus providing a unpressurized impression technique. The impression is hence free from distortions, and the surface of which the impression is taken is completely covered.
In an embodiment with a high fraction of propellant gas in the foam, the material may advantageously be provided in conjunction with a special impression tray which has an inlet for foam supplied, for example, from a spray can, which seals lateral surfaces and has at least one outlet for excess foam, such that any excess foam does not enter the throat. The invention therefore also relates to an impression tray configured in this manner.
In another embodiment, an individual impression tray may be produced directly from a foam according to the invention. When the hardening foam has a sufficiently high final hardness and a high elastic module, it forms a rigid body after separation from the surface of which the impression is made, and can then form the basis for a second impression according to a correction process. The first impression has herein the same intended purpose as a separate impression tray.
Advantageously, a foam according to the invention with a high bulk density (<50% gas volume in the hardened foam) may be provided for a correction impression. The high bulk density may be attained, for example, with a small fraction of a foaming agent.
It will be understood that a suitable embodiment of the foam of the invention may also be used for producing a site impression.
The foam of the invention, provided it has a suitable viscosity and contains an adequate foaming agent fraction, may also be used for expanding the sulcus or as a type of expanding extraction filament.
The foam may also be employed as a placeholder on tooth stumps, for bracing teeth, as well as for producing personal mouth guards for sports activities.
Because the expansion characteristic of the mixture can be precisely adjusted, the foam may also be used for making impressions of other body surfaces in addition to dental surfaces and interior surfaces—for example, the material may be used for producing ear impressions.
The foam may advantageously be applied through release from pressurized cans.
The foaming agent may be a propellant gas, e.g., nitrogen or carbon dioxide, low-molecular hydrocarbons, such as pentane, butane, propane and mixtures thereof, or gas-forming chemicals, such as sodium bicarbonate with citric acid.

### BRIEF DESCRIPTION OF THE DRAWINGS

FIG. 1 shows an impression tray modified according to the invention;

FIG. 2 shows an impression tray modified according to the invention, which optionally includes a stronger dam facing the throat;

FIGS. 3a and b show an embodiment with two-chamber pressurized cartridges and the corresponding impression tray;

FIGS. 3a and b show an embodiment with two-chamber pressurized cartridges having different foaming agent fractions.

The impression tray of the invention includes passageways 1 for supplying and discharging the foam. Also visible is the circular dam 2 for sealing the transition tray/gum.

In another embodiment, the impression tray may be provided with a stronger dam 3 facing the throat.

Suitable materials for the foam according to the invention are, for example, systems based on isocyanate which react, for example, with mono- and multi-functional amines and/or compounds having hydroxyl groups by forming urethane or urea, also A- or C-silicone and polyether, or mixtures thereof. Particularly suited are materials based on a tri-, di- or mono-alkoxy-α-silane (e.g., an α-amino-trimethoxy-silane).

The preferably employed alpha-silanes are available, for example, from the company Wacker. They are presently used in building foams, for example for attaching door components and for insulation. The foams have a significantly lower toxicity than conventional isocyanate-based foams.

A foam can be formed by selecting a suitable primary packing material which introduces, for example in the mixing device, into the impression material gases, which provide the material with a foam-like structure after the material exits the mixing device.

Preferably, foaming agents such as nitrogen or carbon dioxide, low-molecular hydrocarbons, such as pentane, butane, propane and mixtures thereof, or gas-forming chemicals, such as sodium bicarbonate with citric acid, are used which are directly added either to the base component, or to the catalyst component, or to both components.

The foaming agent and the propellant nay also be separated in multi-chamber containers, whereby the characteristic material properties can be precisely adjusted for a particular application.

Particularly preferred embodiments of the invention will now be described with reference to the following examples Parts and percentages refer to weight unless indicated otherwise:

### EXAMPLE 1

An impression material consisting of

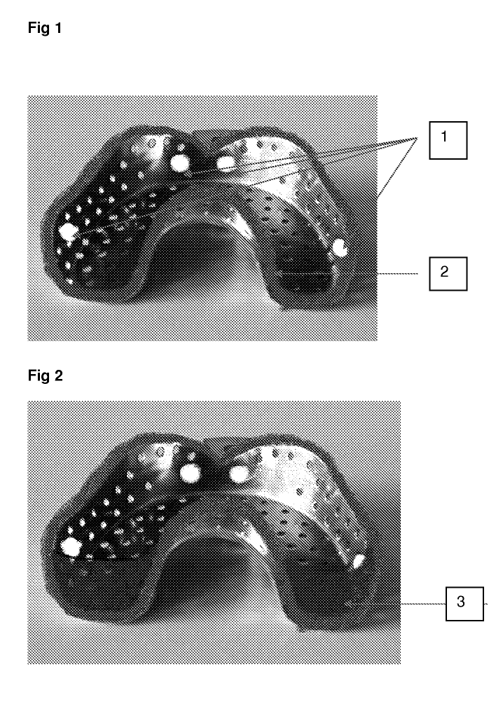

a) a base paste of an A-silicone impression material with a typical commercially used composition, in this case the commercial product Flexitime Correct Flow¹ (Charge 250327) from the company Haraeus Kulzer GmbH, and Note: ¹ The impression material Flexitime is a two-phase, addition-cross-linked, polyvinyl siloxane (see 3.3). it consists of a high-viscosity (Heavy-Tray) and a low-viscosity (Correct Flow) phase. In the Heavy-Tray-phase, the base paste and the reactor paste are mixed in the so-called Penta-Mixer. The Correct-Flow-phase is mixed with a mixing cannula and dispenser and applied manually. The curing time of the phases is 3.5-5 minutes. In the addition-cross-linked silicones (A-silicones) the base component includes linear chains with vinyl end groups. The reactor component is composed of organo-hydrogen-siloxanes. Organic platinum compounds function as catalyst. When the two components are mixed, ethyl bridges are formed, without producing low-molecular, volatile substances (poly-addition).
b) a catalyst paste of the commercial product Flexitime Correct Flow (Charge 250334), is filled into two-chamber pressurized gas cartridges. In this example, the propellant is pentane (see FIG. 2a). Application is made, for example, using commercial applicators (FIG. 2b) and employing commercial static mixers.

The handling time of the impression material is significantly reduced compared to a manually operated impression gun in which a 50 ml solid cartridge is inserted. The impression material can hence be applied with significantly improved dosing and better placement, because the mixing nozzle does not move back and forth as a result of a manual pumping motion.

Surprisingly, unlike the conventional material supplied from a solid cartridge and mixed with a static mixer, the formed silicone has a foam structure. The Shore A hardness is thereby reduced by about 10 units to 36 units (measured 10 minutes after the start of the mixing process). The processing time and curing time of this A-silicone are similar to those of the conventional product. The pores in the cured impression material are located almost entirely inside the hardened material, whereas the surface of the impression is almost bubble-free and extremely uniform.

### EXAMPLE 2

An impression material consisting of

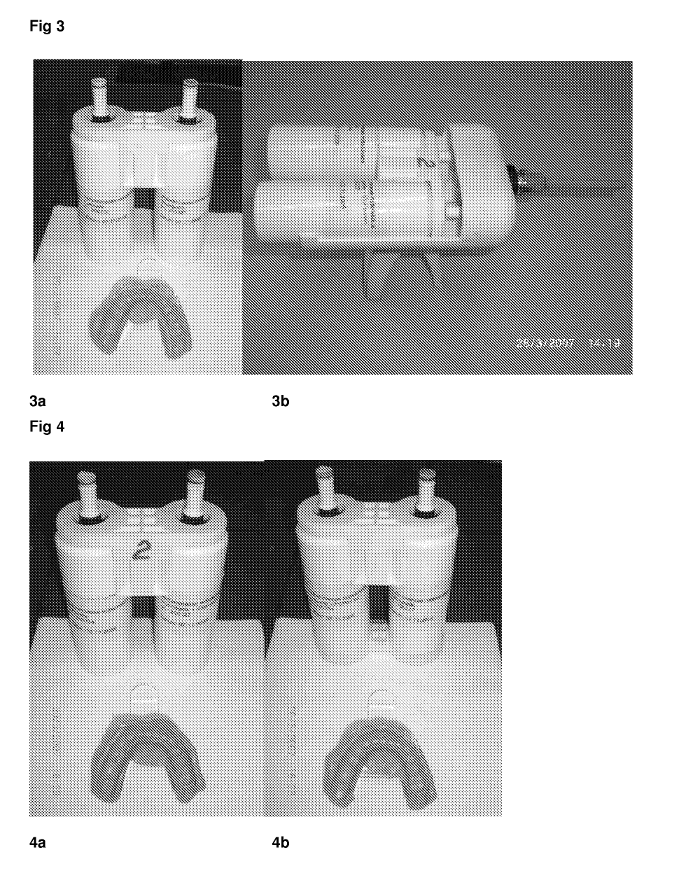

a) a base paste of an A-silicone impression material with a typical commercially used composition, in this case the commercial product Flexitime Correct Flow (Charge 250327) from the company Haraeus Kulzer GmbH, and
b) a catalyst paste of the commercial product Flexitime Correct Flow (Charge 250334), is filled into two-chamber pressurized gas cartridges. In this example, the propellant is pentane; in addition, 5% pentane are added to the base paste as foaming agent and internal propellant (see FIG. 3a). Application is made, for example, using commercial applicators (FIG. 3b) and employing commercial static mixers.

The handling time of the impression material is significantly reduced compared to a manually operated impression gun in which a 50 ml solid cartridge is inserted. The impression material can hence be applied with significantly improved dosing and better placement, because the mixing nozzle does not move back and forth as a result of a manual pumping motion.

As expected, unlike the conventional material supplied from a solid cartridge and mixed with a static mixer, the formed silicone has a foam structure. The Shore A hardness is thereby reduced by about 19 units to 27 units (measured 10 minutes following the start of the mixing process). It can be visually observed that the volume of the impression material increases continually by about 10 to 15% until the time of setting, thus exhibiting the desired foaming pressure commensurate with the intended application. The processing time and curing time of this A-silicone are similar to those of the conventional product. The pores in the cured impression material are in this case also located almost entirely inside the hardened material, whereas the surface of the impression is almost bubble-free and extremely uniform.

Due to its high elasticity and damping characteristic, a silicone material similar to the present structure appears to be suitable as a mouth guard for sports activities.

### EXAMPLE 3

An impression material consisting of

a) a base paste of an A-silicone impression material with a typical commercially used composition, in this case the commercial product Flexitime Correct Flow (Charge 250327) from the company Haraeus Kulzer GmbH, and
b) a catalyst paste of the commercial product Flexitime Correct Flow (Charge 250334),
is filled into two-chamber pressurized gas cartridges.

In this example, the propellant is pentane. In addition, 2% pentane are added to the catalyst paste as foaming agent and internal propellant (see FIG. 4a). Application is made, for example, using commercial applicators (FIG. 3b) and employing commercial static mixers.

The handling time of the impression material is significantly reduced compared to a manually operated impression gun in which a 50 ml solid cartridge is inserted. The impression material can hence be applied with significantly improved dosing and better placement, because the mixing nozzle does not move back and forth as a result of a manual pumping motion.

As expected, unlike the conventional material supplied from a solid cartridge and mixed with a static mixer, the formed silicone has a foam structure. The Shore A hardness is thereby reduced by about 17 units to 29 units. It can be visually observed that the volume of the impression material increases continually by about 10 to 15% until the time of setting, thus exhibiting the desired foaming pressure commensurate with the intended application. The processing time and curing time of this A-silicone are similar to those of the conventional product. The pores in the cured impression material are in this case also located almost entirely inside the hardened material, whereas the surface of the impression is almost bubble-free and extremely uniform.

1. Foam-generating, self-supportingly hardening composition for making impressions of biological surfaces comprising A at least one impression material based on
i isocyanates, which react with mono- and multi-functional amines and/or materials having hydroxyl groups, to form urethane or urea, or
ii A-silicones, or
iii C-silicones, or
iv polyethers, or
v alpha-silanes, or
vi mixtures of two or more of the materials i to v,
as well as
optionally B
at least one foaming agent.

2. Composition according to claim 1, comprising as component A the base paste of an A-silicone impression material and the catalyst paste of an A-silicone impression material.

3. Composition according to claim 1, comprising as component A an impression material based on at least one tri-, di-, or monoalkoxy-alpha-silane.

4. Composition according to claim 1, comprising as component A the base paste of a polyether impression material and the catalyst paste of a polyether impression material.

5. Composition according to claim 1, comprising as component A an impression material based on an alpha-amino-trimethoxy-silane.

6. A method for producing a means for making an impression of surfaces, which comprises producing such means with the hardening composition of claim 1.

7. A method for producing a means for making an impression of biological surfaces, which comprises producing said means with the hardening composition of claim 1.

8. A method for producing an impression material for making an impression of teeth, body parts, skin or plant parts in humans, animals or plants, which comprises producing said impression material with the hardening composition of claim 1.

9. A method for producing a means for making an impression of dental surfaces, which comprises producing said means with the hardening composition of claim 1.

10. A method for producing a means for forming placeholders on tooth stumps, which comprises producing said means with the hardening composition of claim 1.

11. A method for producing a means for bracing teeth, which comprises producing said means with the hardening composition of claim 1.

12. A method for producing a personal mouth guard for sports activities which comprises producing said mouth guard with the hardening composition of claim 1.

13. A method for producing individual impression trays, which comprises producing said individual impression trays with the hardening composition of claim 1.

14. A method for producing a means for correction impressions, which comprises producing said means with the hardening composition of claim 1, wherein the gas volume of the foam is <50%.

15. A method for producing a means for expanding the sulcus similar to an expanding extraction filament by using a foam containing a foaming agent, which comprises producing said means with the hardening composition of claim 1.

16. A method for producing an impression material for making an impression of body parts for fabricating individually fitted appliances selected from the group consisting of shoe inserts, orthopedic appliances, seat adjustments and hearing aids, which comprises producing said impression material with the hardening compound of claim 1.

17. Impression tray for the hardening composition of claim 1, wherein the impression tray comprises
at least one inlet for generated foam,
means (2) for the sealing the lateral surfaces, and
at least one outlet (1) for excess foam,
so as to prevent excess foam from entering the throat.

18. Impression tray according to claim 16, which is additionally provided with a stronger dam (3) facing the throat.

19. Impression of biological surfaces made of an impression material based on
i isocyanates, which react with mono- and multi-functional amines and/or compounds having hydroxyl groups, to form urethane or urea, or
ii A-silicones, or
iii C-silicones, or
iv Polyethers, or
v alpha-silanes, or
vi mixtures of two or more materials i to v,
wherein the impression has a foam with closed pores.

20. Impression according to claim 19, wherein the impression is a dental impression.

21. Impression according to claim 19 wherein the impression is self-supporting.

22. Impression according to claim 20 wherein the impression is self-supporting.

22. Impression according to claim 19, wherein the impression is elastic and dimensionally stable.

23. Impression according to claim 20, wherein the impression is elastic and dimensionally stable.

24. Impression according to claim 21, wherein the impression is elastic and dimensionally stable.
